(19) United States
(12) Patent Application Publication
(10) Pub. No.: US 2025/0298978 A1
(43) Pub. Date: Sep. 25, 2025

(54) METHODS AND SYSTEMS FOR SEGMENTING CONVERSATION SESSION AND PROVIDING CONTEXT TO A LARGE LANGUAGE MODEL

(71) Applicant: Shopify Inc., Ottawa (CA)

(72) Inventors: Neil Leonard PADGETT, Toronto (CA); Kshetrajna RAGHAVAN, Fremont, CA (US); Eric Andrew FLORENZANO, San Francisco, CA (US)

(21) Appl. No.: 18/736,789

(22) Filed: Jun. 7, 2024

Related U.S. Application Data
(60) Provisional application No. 63/567,288, filed on Mar. 19, 2024.
(60) Provisional application No. 63/637,608, filed on Apr. 23, 2024.

(51) Int. Cl. G06F 40/284; G06F 16/33

(52) U.S. Cl. CPC G06F 40/284; G06F 16/3344

(57) ABSTRACT

Methods and systems for segmenting a conversation session and providing context to a generative language model are described. A conversation history is maintained for an ongoing conversation session. The conversation history contains conversation segments, where each conversation segment is associated with at least one topic and includes previous message(s) in the conversation session. A new message is received for the conversation session, and topic(s) associated with the new message are determined. The conversation history is filtered based on relevance to the topic(s) associated with the new message. The filtered conversation history has a relevant conversation segment associated with a topic that is relevant to the topic(s) associated with the new message. A prompt is provided to a generative language model based on the filtered conversation history and the new message. A message is outputted based on output generated by the generative language model in response to the prompt.

### CROSS-REFERENCE TO RELATED APPLICATION

The present disclosure claims priority from U.S. provisional patent application No. 63/567,288, filed Mar. 19, 2024, entitled “SELECTIVELY INCLUDE SPECIFIC MESSAGES IN LLM CHAT MESSAGE HISTORY FOR SPECIALISING OUTPUT USING TOPIC ANALYSIS”; and U.S. provisional patent application No. 63/637,608, filed Apr. 23, 2024, entitled “METHODS AND SYSTEMS FOR SEGMENTING CHAT SESSION AND PROVIDING CONTEXT TO AN LLM”, all of which are hereby incorporated by reference in their entireties.

### FIELD

The present disclosure relates to machine learning and large language models (LLMs), and, more particularly, to operation of an LLM in the context of a conversation session.

### BACKGROUND

A large language model (LLM) is a deep learning algorithm that can process natural language to summarize, translate, predict and generate text and other content. A LLM may be trained to learn billions of parameters in order to model how words relate to each other in a textual sequence. Inputs to a LLM may be referred to as prompts. A prompt is a natural language input that includes instructions to cause the LLM to generate a desired output.

A user may interact with an LLM by providing messages to and receiving messages from the LLM in a conversation session. In such a scenario, the user may interact with an LLM via a chatbot.

### SUMMARY

A client system (e.g., a user device or other computing system) may conduct a conversation session with an LLM. A conversation session may be a chat-based session (e.g., where a user interacts with the LLM via natural language inputs to a chatbot) or an exchange of messages from a client computing system and the LLM, among other possibilities. During a conversation session, a conversation history may be maintained that contains the messages in the conversation session. As the conversation session is ongoing, each new message in the conversation session is added to the conversation history. As such, the conversation history is not static and increases in size (e.g., in the number of messages) as the conversation proceeds. The conversation history may contain text. Additionally or alternatively, the conversation history may contain images, audio and other media formats such as, for example, in the case of multi-modal LLMs (e.g., BLIP-2, CLIP, GPT-4V). When a new message is provided to “chat” with the LLM (e.g., based on input from the client system), the new message may be provided in a prompt to the LLM together with messages from the conversation history. In this way, the LLM may be prompted to generate a response to the new message that takes into account the conversation history.

A drawback of this approach is that when the topic of conversation changes, portions of the conversation history relating to earlier topics can continue to be provided as a part of the input to the LLM, despite their possible irrelevance. As a result, the LLM may generate erroneous or incorrect outputs, particularly if the change in topic is significant. This may be because all of the prior messages provided as input to the LLM affect the state of the LLM. As well, because instructions or context that were relevant to an earlier topic may become irrelevant or misleading when the conversation shifts to another topic, prior messages may become not only irrelevant but can serve to misdirect the LLM to states where it generate outputs that may be less optimal and/or less relevant than if that irrelevant input had not been allowed to affect the LLM state. In effect, the irrelevant portions of the input can lead to LLM outputs that are predicated, at least in part, on less relevant or potentially irrelevant or inappropriate portions of the message history. Providing such low relevance portions may thereby result in inaccurate output from the LLM.

Additionally or alternatively, inclusion of every message in the conversation history in a prompt to the LLM can lead to more rapid exhaustion of token resources as well as wasted compute resources when the LLM processes an ever expanding list of prior messages. Each word in the prompt is generally processed by the LLM as one or more tokens, where a token represents a sequence of characters in the vocabulary the LLM has been trained on. The tokens are processed by the LLM's underlying transformer architecture, which contains a number of layers that perform complex vector computation and matrix operations on each token. When a prompt is provided to the LLM, the prompt is converted to tokens. The LLM processes these tokens one at a time, and tokens may be stored in a temporary memory such as a buffer until they can be processed. This means that there is a limit to the number of tokens that can be provided to the LLM. The token limit is dependent on the LLM, and can range from as low as 4096 tokens (e.g., ChatGPT-3.5 Turbo Instruct) or lower to as high as 128,000 tokens (e.g., GPT-4o) or higher. However, even higher token limits can be quickly reached if the prompt includes all messages in a conversation history. In cases where the topic of conversation changes, if the entire conversation history is provided as input to the LLM this means that tokens related to previous, now irrelevant, topics are still processed by the LLM. As the conversation continues and the conversation history grows, the number of tokens processed continues to increase, thus leading to greater and greater consumption of tokens for each subsequent message processed by the LLM along with the ever growing prior conversation history. This can even lead to exhaustion of tokens such as, for example, where input token limits are reached. It should be noted that the token limit for the LLM applies to the entire input to the LLM (e.g., including special characters, code, natural language text, etc.) and that the token limit is shared between the input to the LLM and the output generated by the LLM.

Additionally or alternatively, from the perspective of computational resources, when tokens from earlier portions of the conversation are included in the history, the system expends computational resources (e.g., processing power, memory, high-performance GPUs, computing time etc.) processing all of those tokens (e.g., because each of those tokens must be input/fed into the LLM's transformer architecture and processed thereby). When some of all of those earlier portions is irrelevant to the current portion or thrust of the conversation, the system must nonetheless expend resources on processing the tokens associated with such earlier portions even though they may not be needed in order for the LLM to generate a relevant response to the current input. Additionally, in some cases including such irrelevant portions may serve to reduce the relevance and/or quality of the response the LLM provides are compared to if such portions were not included in the input.

In various examples, the present disclosure provides a technical solution for filtering the conversation history of an ongoing conversation session between a user and an LLM such that the LLM is provided with a portion of the conversation history that is relevant to the topic of a current message. The disclosed solution enables an LLM to be provided with contextual information, such as the filtered conversation history, that enables generation of more accurate output, while at the same time reducing the number of tokens required by reducing the size of the conversation history provided to the LLM. The disclosed solution also may enable the LLM to generate more relevant output by reducing or removing irrelevant portions of the conversation history from being provided to the LLM.

Examples disclosed herein maintain the conversation history of a conversation session with an LLM by storing the conversation history in segments and using topic modelling to automatically identify the topic of each segment. The database of conversation segments (where each segment can contain more than one message) is maintained and grows during a current, ongoing conversation session. Thus, the conversation history is not a static document, but rather provides dynamic and tailored context to enable the LLM to generate output that is specific to the ongoing conversation session. Additionally, because messages within a conversation segment and in the conversation history are maintained in their original consecutive temporal order, the temporal order of the messages can also provide useful contextual information to the LLM.

In an example aspect, the present disclosure describes a computer-implemented method including: maintaining a conversation history for an ongoing conversation session, the conversation history containing conversation segments of the ongoing conversation session, each conversation segment being associated with at least one topic, and each conversation segment including one or more previous messages in the ongoing conversation session; receiving a new message for the ongoing conversation session; determining one or more topics associated with the new message; filtering the conversation history based on relevance to the one or more topics associated with the new message to obtain a filtered conversation history having at least one relevant conversation segment associated with at least one topic that is relevant to the one or more topics associated with the new message; providing a prompt to a generative language model based on the filtered conversation history and the new message; and providing an output message based on output generated by the generative language model in response to the prompt.

In an example of the preceding example aspect of the method, the method may include: determining, based on the one or more topics associated with the new message, that a particular conversation segment in the conversation history that is temporally closest to the new message is associated with at least one topic that is similar to or same as at least one of the one or more topics associated with the new message; and storing the new message to the particular conversation segment in the conversation history.

In an example of any of the preceding example aspects of the method, the method may include: determining, based on the one or more topics associated with the new message, that all of the at least one topic associated with a particular conversation segment in the conversation history that is temporally closest to the new message are dissimilar to the one or more topics associated with the new message; creating a new conversation segment in the conversation history associated with the one or more topics associated with the new message; and storing the new message to the new conversation segment.

In an example of any of the preceding example aspects of the method, at least two conversation segments in the conversation history that are associated with at least two respective different topics may have at least one overlapping message in common, the at least one overlapping message being associated with both of the at least two respective different topics.

In an example of any of the preceding example aspects of the method, the one or more previous messages stored in each conversation segment may be temporally consecutive messages stored in temporal order.

In an example of any of the preceding example aspects of the method, filtering the conversation history may include: identifying the at least one relevant topic based on a measure of similarity between the at least one relevant topic and the one or more topics associated with the new message; and excluding at least some conversation segments in the conversation history that are associated with topics other than the at least one relevant topic.

In an example of the preceding example aspect of the method, the method may include: generating a summary of at least one of the excluded conversation segments; wherein the prompt provided to the generative language model is further based on the generated summary.

In an example of any of the preceding example aspects of the method, the ongoing conversation session may be associated with an account, the method further comprising: maintaining a historical database containing historical messages from one or more historical conversation sessions associated with the account, the historical database containing historical conversation segments that each belong to a respective historical conversation session, each historical conversation segment being associated with at least one topic, and each historical conversation segment including one or more historical messages of the respective historical conversation session; and identifying at least one historical conversation segment associated with the at least one relevant topic that is relevant to the one or more topics associated with the new message; wherein the prompt provided to the generative language model is further based on the identified at least one historical conversation segment.

In an example of any of the preceding example aspects of the method, determining the one or more topics associated with the new message may include: using a sliding window to define a defined number of one or more most recent messages; providing the new message together with the one or more most recent messages to a trained model; and receiving the one or more topics as output from the trained model.

In an example of any of the preceding example aspects of the method: previous messages in the ongoing conversation session may be clustered, each cluster corresponding to a conversation segment associated with at least one topic. Determining the one or more topics associated with the new message may include: using a clustering algorithm to cluster the new message with a particular cluster; and determining the one or more topics associated with the new message based on the at least one topic associated with the conversation segment corresponding to the particular cluster. Filtering the conversation history may include: selecting the conversation segment corresponding to the particular cluster as the filtered conversation history.

In another example aspect, the present disclosure describes a computer system including at least one processor; and a computer readable medium storing instructions that, when executed by the at least one processor, cause the computer system to: maintain a conversation history for an ongoing conversation session, the conversation history containing conversation segments of the ongoing conversation session, each conversation segment being associated with at least one topic, and each conversation segment including one or more previous messages in the ongoing conversation session; receive a new message for the ongoing conversation session; determine one or more topics associated with the new message; filter the conversation history based on relevance to the one or more topics associated with the new message to obtain a filtered conversation history having at least one relevant conversation segment associated with at least one topic that is relevant to the one or more topics associated with the new message; provide a prompt to a generative language model based on the filtered conversation history and the new message; and provide an output message based on output generated by the generative language model in response to the prompt.

In an example of the preceding example aspect of the computer system, the instructions when executed by the at least one processor may further cause the computer system to:
determine, based on the one or more topics associated with the new message, that a particular conversation segment in the conversation history that is temporally closest to the new message is associated with at least one topic that is similar to or same as at least one of the one or more topics associated with the new message; and store the new message to the particular conversation segment in the conversation history.

In an example of any of the preceding example aspects of the computer system, the instructions when executed by the at least one processor may further cause the computer system to: determine, based on the one or more topics associated with the new message, that all of the at least one topic associated with a particular conversation segment in the conversation history that is temporally closest to the new message are dissimilar to the one or more topics associated with the new message; create a new conversation segment in the conversation history associated with the one or more topics associated with the new message; and store the new message to the new conversation segment.

In an example of any of the preceding example aspects of the computer system, at least two conversation segments in the conversation history that are associated with at least two respective different topics may have at least one overlapping message in common, the at least one overlapping message being associated with both of the at least two respective different topics.

In an example of any of the preceding example aspects of the computer system, the one or more previous messages stored in each conversation segment may be temporally consecutive messages stored in temporal order.

In an example of any of the preceding example aspects of the computer system, the instructions when executed by the at least one processor may further cause the computer system to filter the conversation history by: identifying the at least one relevant topic based on a measure of similarity between the at least one relevant topic and the one or more topics associated with the new message; and excluding at least some conversation segments in the conversation history that are associated with topics other than the at least one relevant topic.

In an example of the preceding example aspect of the computer system, the instructions when executed by the at least one processor may further cause the computer system to: generate a summary of at least one of the excluded conversation segments; wherein the prompt provided to the generative language model is further based on the generated summary.

In an example of any of the preceding example aspects of the computer system, the instructions when executed by the at least one processor may further cause the computer system to determine the one or more topics associated with the new message by: using a sliding window to define a defined number of one or more most recent messages; providing the new message together with the one or more most recent messages to a trained model; and receiving the one or more topics as output from the trained model.

In an example of any of the preceding example aspects of the computer system, previous messages in the ongoing conversation session may be clustered, each cluster corresponding to a conversation segment associated with at least one topic. The instructions when executed by the at least one processor may further cause the computer system to determine the one or more topics associated with the new message by: using a clustering algorithm to cluster the new message with a particular cluster; and determining the one or more topics associated with the new message based on the at least one topic associated with the conversation segment corresponding to the particular cluster. The instructions when executed by the at least one processor may further cause the computer system to filter the conversation history by: selecting the conversation segment corresponding to the particular cluster as the filtered conversation history.

In another example aspect, the present disclosure describes a non-transitory computer-readable medium storing instructions that, when executed by at least one processor of a computer system, cause the computer system to: maintain a conversation history for an ongoing conversation session, the conversation history containing conversation segments of the ongoing conversation session, each conversation segment being associated with at least one topic, and each conversation segment including one or more previous messages in the ongoing conversation session; receive a new message for the ongoing conversation session; determine one or more topics associated with the new message; filter the conversation history based on relevance to the one or more topics associated with the new message to obtain a filtered conversation history having at least one relevant conversation segment associated with at least one topic that is relevant to the one or more topics associated with the new message; provide a prompt to a generative language model based on the filtered conversation history and the new message; and provide an output message based on output generated by the generative language model in response to the prompt.

In some examples, the computer-readable medium may store instructions that, when executed by the processor of the computing system, cause the computing system to perform any of the example aspect of the methods described above.

In another example aspect, the present disclosure provides a computer program including processor-executable instructions that, when executed by a processor of a computing system, cause the computing system to perform any of the example aspect of the methods described above.

### BRIEF DESCRIPTION OF THE DRAWINGS

Reference will now be made, by way of example, to the accompanying drawings which show example embodiments of the present application, and in which:

FIG. 1A is a block diagram of a simplified convolutional neural network, which may be used in examples of the present disclosure;

FIG. 1B is a block diagram of a simplified transformer neural network, which may be used in examples of the present disclosure;

FIG. 2 is a block diagram of an example computing system, which may be used to implement examples of the present disclosure;

FIG. 3 is a block diagram of an example conversation engine, in accordance with examples of the present disclosure;

FIG. 4 is a flowchart illustrating an example method for providing a filtered conversation history to a LLM, in accordance with examples of the present disclosure; and

FIGS. 5A-5C illustrate a simplified example user interface showing operation of an example conversation engine, in accordance with examples of the present disclosure.

Similar reference numerals may have been used in different figures to denote similar components.

### DETAILED DESCRIPTION

In various examples, the present disclosure describes methods and systems for maintaining a conversation history for an ongoing conversation session, and automatically segmenting the conversation history into conversation segments that are each associated with at least one topic, for example using a trained model. Each new message in a conversation (whether from a client system or based on output generated by the LLM) may be similarly associated with one or more topics and added to a growing conversation segment.

When a new message is received (e.g., inputted via a user device) the topic(s) of the new message can be identified (e.g., using a trained model) and the conversation history may be filtered such that conversation segments associated with topics that are similar or relevant to the topic(s) of the new message can be provided as context in a text prompt to the LLM, rather than providing the entire conversation history as context. In this way, input of irrelevant or less relevant context to the LLM may be avoided or limited. Conveniently, this may allow the LLM to produce more accurate or higher-quality output that is more relevant to the new message. Additionally or alternatively, because the conversation history is filtered, fewer computing resources, including token resources, may be consumed due to the reduced size of the conversation history that has to be processed by the LLM in generating a response to the new message as compared to, for example, a system in which the entire conversation history is input to and processed by the LLM.

While an LLM is discussed in examples of the present disclosure, it should be understood that other types of generative models, including image generation models, and other machine learning models that accept unstructured inputs (e.g., natural language inputs) may benefit from aspects of the present disclosure. As such, the present disclosure is not necessarily limited to implementation with an LLM.

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

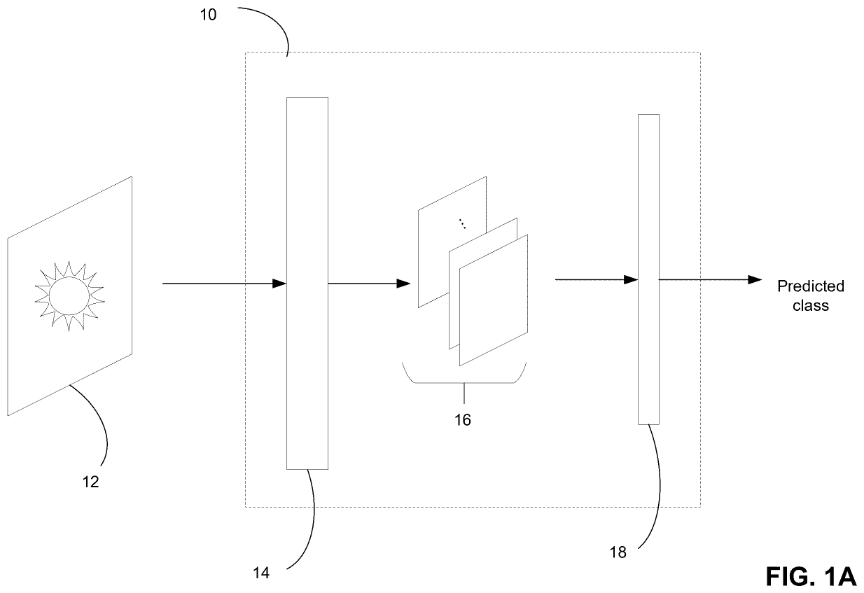

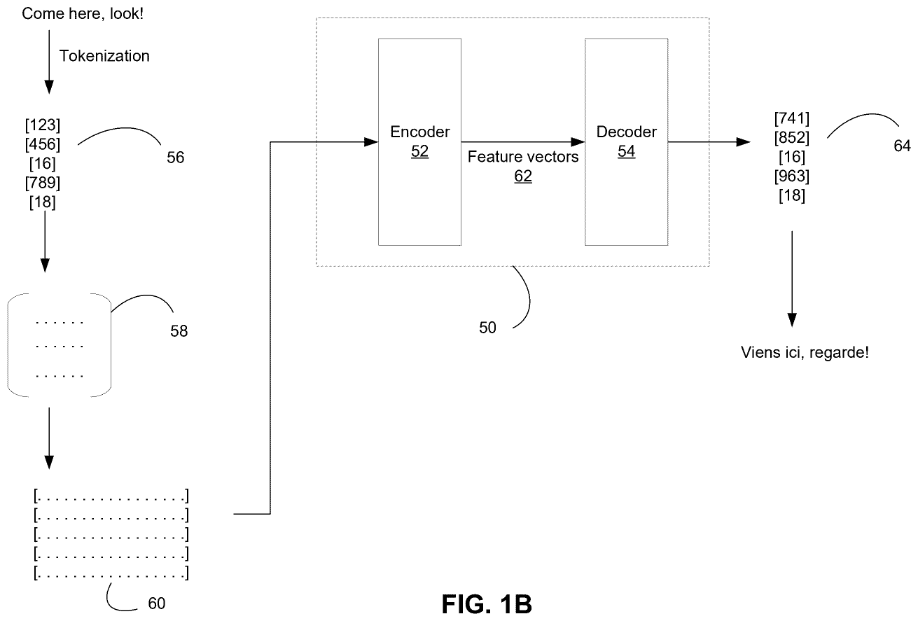

FIG. 1A is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 1B is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabelled. LLMs may be trained on a large unlabelled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 1B, a short sequence of tokens 56 corresponding to the text sequence “Come here, look!” is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

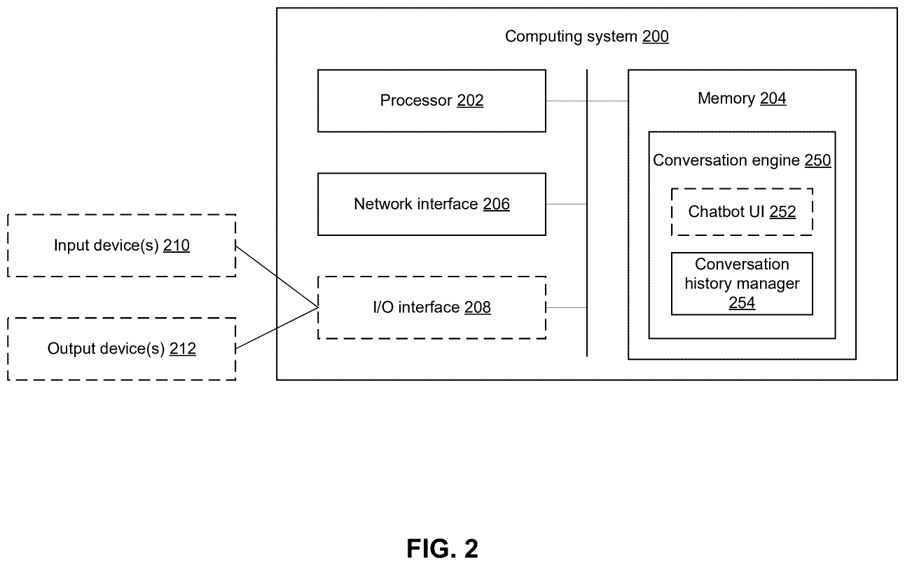

FIG. 2 illustrates an example computing system 200, which may be used to implement examples of the present disclosure. For example, the computing system 200 may be used to generate a prompt to an LLM to cause the LLM to generate output. Additionally or alternatively, one or more instances of the example computing system 200 may be employed to execute the LLM. For example, a plurality of instances of the example computing system 200 may cooperate to provide output using an LLM in manners as discussed above.

The example computing system 200 includes at least one processing unit and at least one physical memory 204. The processing unit may be a hardware processor 202 (simply referred to as processor 202). The processor 202 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 204 may include a volatile or non-volatile memory (e.g., a flash memory, a random access memory (RAM), and/or a read-only memory (ROM)). The memory 204 may store instructions for execution by the processor 202, to cause the computing system 200 to carry out examples of the methods, functionalities, systems and modules disclosed herein.

The computing system 200 may also include at least one network interface 206 for wired and/or wireless communications with an external system and/or network (e.g., an intranet, the Internet, a P2P network, a WAN and/or a LAN). The network interface 206 may enable the computing system 200 to carry out communications (e.g., wireless communications) with systems external to the computing system 200, such as a LLM residing on a remote system.

The computing system 200 may optionally include at least one input/output (I/O) interface 208, which may interface with optional input device(s) 210 and/or optional output device(s) 212. Input device(s) 210 may include, for example, buttons, a microphone, a touchscreen, a keyboard, etc. Output device(s) 212 may include, for example, a display, a speaker, etc. In this example, optional input device(s) 210 and optional output device(s) 212 are shown external to the computing system 200. In other examples, one or more of the input device(s) 210 and/or output device(s) 212 may be an internal component of the computing system 200.

A computing system, such as the computing system 200 of FIG. 2, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

In the example of FIG. 2, the computing system 200 may store in the memory 204 computer-executable instructions, which may be executed by a processing unit such as the processor 202, to implement one or more embodiments disclosed herein. For example, the memory 204 may store instructions for implementing a conversation engine 250, which may include an optional chatbot UI 252 and a conversation history manager 254, as discussed further below.

In some examples, the computing system 200 may be a server of an online platform that provides the conversation engine 250 as a web-based or cloud-based service that may be accessible by a client system, such as a user device, (e.g., via communications over a wireless network). Other such variations may be possible without departing from the subject matter of the present application.

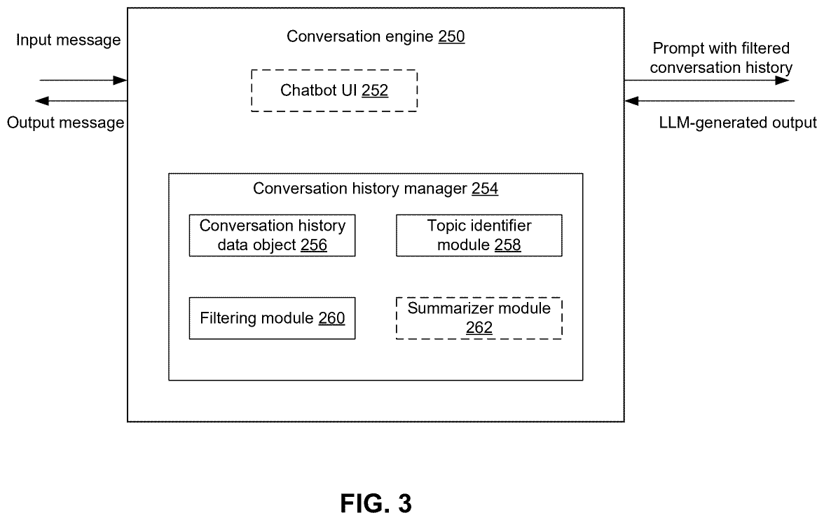

FIG. 3 is a block diagram illustrating details of an example conversation engine 250. The operations of the conversation engine 250 will be described for processing an input message, providing a prompt to an LLM based on the input message, and providing output based on the LLM-generated message, in the context of an ongoing conversation session.

In the present disclosure, an ongoing conversation session may refer to a currently active session between a client system and an LLM (e.g., via the conversation engine 250), where messages (e.g., input messages from the client system or messages based on output generated by the LLM) are maintained in a conversation history at least for the duration of the conversation session. A conversation session may be a chat-based session between a user providing inputs via a user device as the client system and an LLM, or may be an exchange of messages (e.g., system messages) between a client system and the LLM, among other examples. Some examples provided herein may be in the context of a chat-based session in which a user provides natural language input to the LLM via a chatbot UI, however this is not intended to be limiting.

As the conversation session is an ongoing conversation session, the conversation history may increase in size (e.g., increase in the amount of memory required to store the conversation history, increase in the number of words or characters stored and/or increase in the number of messages stored) as messages are added to the conversation session. When a conversation session ends (e.g., by the client system terminating the session, by a timeout, etc.), the conversation history may or may not be stored for future use. In some examples, such as when the conversation session is associated with a registered account (e.g., an account associated with a client system), the conversation history for an ended conversation session may be stored as a historical conversation session in association the account. This may enable the historical messages from previous conversation sessions to be used as context for a current, ongoing conversation session associated with the same account. In some examples, such as when the conversation session is not associated with an account (e.g., the client system does not have a registered account), the conversation history may not be stored after a conversation session ends. In the present disclosure, a conversation history for an ongoing conversation session refers to the conversation history that is still growing as the conversation session is ongoing. Thus, the conversation history may not be a static data object.

In the example shown, the conversation engine 250 includes the optional chatbot UI 252 and the conversation history manager 254. The conversation history manager 254 in this example maintains a conversation history data object 256, includes a topic identifier module 258, includes a filtering module 260 and optionally includes a summarizer module 262. The example shown is not intended to be limiting. It should be understood that there may be greater or fewer modules in the conversation engine 250 and conversation history manager 254. Operations described as being performed by a particular module may be performed by a different module, or may be an overall function of the conversation engine 250, for example.

The conversation engine 250 may communicate with an LLM (not shown) that may be hosted by a remote system external to the computing system 200. For example, the conversation engine 250 may generate and send prompts to the LLM via API calls, and may receive outputs generated by the LLM in response.

The optional chatbot UI 252 may provide an interface for a user to input messages and view output messages in examples where the conversation session is a chat-based session. For example, the chatbot UI 252 may provide an interface in the form of a virtual assistant for an application, a website or portal, among other applications. In some examples, the chatbot UI 252 may be configured to render user interface elements in the chat-based session. For example, the LLM may be pre-trained to generate output that includes code that the chatbot UI 252 may use to render user interface elements in the chat-based session.

Messages in the conversation session, including both input messages from the client system as well as output messages based on LLM generated output, may be included in the conversation history of the ongoing conversation session. The conversation history manager 254 performs operations to maintain the conversation history as a conversation history data object 256. The conversation history data object 256 may be a dynamic data object 256 that grows as messages are added to the ongoing conversation session. The conversation history data object 256 may store the conversation history of the ongoing conversation session as conversation segments (e.g., each conversation segment may correspond to a respective record in the conversation history data object 256, or each message in the conversation history may be a respective record in the conversation history data object 256 and a conversation segment may be a group of records in the conversation history data object 256; any other suitable data structure may be used). A conversation segment includes one or more previous messages in the ongoing conversation session, stored in consecutive temporal order (e.g., in the order that the messages were added to the conversation session), and each conversation segment is associated with at least one topic. In some examples, conversation segments may be overlapping. For example, if two conversation segments are associated with two different topics, there may be an overlapping message in common between the two conversation segments, where the overlapping message is associated with both of the two different topics.

When a new message is added to the ongoing conversation session, whether an input message or output message based on LLM generated output, the new message may be processed using the topic identifier module 258 to identify one or more topics associated with the new message. The topic identifier module 258 may identify one or more topics associated with the new message using, for example, a clustering approach, using an LLM approach or other trained model approach.

For example, in a clustering approach, the topic identifier module 258 may include an embedding encoder that encodes each message into an embedding (e.g., based on a trained model such as BERT). The previous messages in the conversation session have all been previously encoded into respective embeddings. The topic identifier module 258 may use any suitable clustering algorithm to cluster the embeddings, where all embeddings belonging to the same cluster are considered to correspond to messages associated with the same or similar topic. Messages sampled from a cluster may be provided to a trained natural language processing (NLP) model or LLM (which may or may not be the same as the LLM that is used to generate output messages in the conversation session) to identify one or more topics associated with the cluster. When a new message is added to the conversation session, the topic identifier module 258 encodes the new message into a corresponding embedding and uses the clustering algorithm to identify the cluster (if any) to which the new message belongs. Then the topic(s) associated with that cluster may be identified as the topic(s) associated with the new message. In some examples, the timestamp of each message may be included when encoding the embedding, so that temporal information is encoded in the embedding. This may enable the clusters to reflect the temporal proximity of the messages, for example two messages relating to the same topic but separated by a large temporal gap may be placed into two different clusters.

In another example, the topic identifier module 258 may generate a prompt to an LLM (which may or may not be the same as the LLM that is used to generate output messages in the conversation session) or other NLP model that includes the new message and an instruction to identify one or more topics associated with the new message. In some examples, a sliding window may be used such that some amount of previous messages (e.g., a certain number of most recent messages, or a certain number of characters or words from most recent messages) is included together with the new message, which may provide context to enable a trained model to more accurately identify at least one topic associated with the new message. For example, an input message may be ambiguous and/or may be too short to accurately identify a topic unless some prior message is included (e.g., the message “I want it red” may lack meaning without the prior message “I want to make the webpage look different”).

In another example, some other trained model, such as a multi-class classifier, may be used to process the new message and predict the topic, from a set of defined topics, that is associated with the new message.

In any of the approaches described above, a confidence score may be associated with each topic identified for the new message, which may indicate the confidence associated with a topic identified by an LLM or other trained model. In some examples, a topic associated with a low confidence score (e.g., below 50% or below 70% confidence) may be discarded and not associated with the new message.

The new message with the associated one or more topics are then added to the conversation history data object 256. If the topic(s) associated with the new message are similar to or same as at least one topic associated with the most recent conversation segment (that is, the conversation segment in the conversation history that is temporally closest to the new message), then the new message may be stored to the recent conversation segment (thus “growing” the conversation segment) in the conversation history data object 256. If the topic(s) associated with the new message are all dissimilar to the topic(s) associated with the most recent conversation segment, a new conversation segment may be created in the conversation history. The new conversation segment is used to store the new message and is associated with the topic(s) that have been identified for the new message. It should be noted that the new conversation segment may be created even if there is an earlier conversation segment, not temporally closest to the new message, that is associated with a topic similar to the topic(s) of the new message. This means that there may be multiple conversation segments in the conversation history data object 256 that store messages associated with the same or similar topics, but temporally separated.

Similarity or dissimilarity with the topic(s) of the most recent conversation segment may be determined using any suitable approach. For example, the topic(s) associated with the most recent conversation segment may be encoded as embedding(s) (e.g., using a trained model such as BERT), and similarly the topic(s) associated with the new message may be encoded as embedding(s). Then a similarity measure between embeddings may be used (e.g., based on Euclidean distance between embeddings) to determine if the topic(s) of the new message are similar to the topic(s) of the most recent conversation segment. A conversation segment may be considered to be relevant to the new message if the topic similarity is within some defined threshold (e.g., the distance between embeddings corresponding to the topics of the conversation segment and new message is smaller than some defined threshold). In some examples, the new message may be added to the most recent conversation segment by default, unless the topic(s) identified for the new message has been identified with a sufficiently high confidence. In some examples, a clustering algorithm may be used to cluster the new message with a particular cluster of previous messages in the conversation session, as discussed above, and the new message may be stored to the conversation segment corresponding to that particular cluster.

The conversation engine 250 may use the filtering module 260 to filter the conversation history based on relevance to the topic(s) associated with the new message. The filtered conversation history includes at least one conversation segment that is associated with a topic that is relevant to the topic(s) associated with the new message. For example, if the new message has been added to the most recent conversation segment, then the most recent conversation segment may be included in the filtered conversation history. There may be older conversation segments with topic(s) relevant to the topic(s) of the new message that can also be included in the filtered conversation history. In some examples, the filtering module 260 may limit the amount of messages to be included in the filtered conversation history. For example, the filtering module 260 may include a fixed number (e.g., 1-3) of the most recent conversation segments with topic(s) relevant to the topic(s) of the new message to include in the filtered conversation history. In another example, the filtering module 260 may include as many relevant conversation segment(s) as can fit into some set maximum (e.g., up to 500 tokens, up to 4 kB, etc.), where more recent conversation segments are prioritized over older conversation segments. In some examples, the filtering module 260 may start by selecting conversation segments having the highest relevance (e.g., based on vector similarity of corresponding embeddings) to the new message and if the set maximum has not been reached after the highest relevance conversation segments have all been selected, then the next-most relevant conversation segments may be selected, and so forth until the set maximum is reached. In some examples, the filtering module 260 may filter the conversation history in a manner that preserves the temporal order of the conversation segments. For example, after selecting the relevant conversation segments (e.g., by selecting conversation segments in order of relevance up to some set maximum, or by selecting only conversation segments that satisfy a relevance threshold, etc.), the filtering module 260 may maintain the temporal order of the selected conversation segments in accordance with the temporal order in the conversation history. Maintaining the temporal order of the conversation segments in the filtered conversation history may help to provide contextual information that might otherwise be lost if the conversation segments were out of temporal order. In some examples, the filtering module 260 may exclude conversation segments older than some temporal threshold (e.g., older than 1 hour) from the filtered conversation history regardless of topic similarity.

A conversation segment may be considered to be relevant to the topic(s) associated with the new message (and thus may be included in the filtered conversation history) based on vector similarly of corresponding embeddings as discussed previously, for example. In another example, if there is a defined set of topics, a conversation segment may be considered to be relevant to the topic(s) associated with the new message if the conversation segment has at least one topic in common with the new message. In examples where a conversation segment is associated with multiple topics, a conversation segment may be considered to be relevant (and thus may be included in the filtered conversation history) if some minimum number of topics (e.g., at least 50%) associated with the conversation segment are relevant to the topic(s) of the new message.

In some examples, the filtering module 260 may always include some amount of most recent messages in the conversation session (e.g., 1-3 messages, a set number of bytes or tokens of most recent messages, messages associated with 1-3 most recent topics, possibly up to some maximum limit) regardless of topic relevance. This may help to provide context about the ongoing conversation session.

As discussed above, the filtering module 260 may exclude one or more conversation segments that are associated with dissimilar topics from the filtered conversation history. Optionally, a summarizer module 262 may be used to generate a summary of at least some of the excluded conversation segments, which may be useful to provide context to enable the LLM to more accurately generate an output message. For example, after the filtering module 260 has identified the conversation segment(s) to be included in the filtered conversation history, the summarizer module 262 may use a trained summarization model to generate a summary for all or some of the excluded conversation segment(s). In some examples, the summarizer module 262 may make use of an NLP model or an LLM (which may or may not be the same as the LLM that is used to generate output messages in the conversation session) to generate a summary of all or some of the excluded conversation segment(s). The summarizer module 262 may generate a summary for only a defined number (e.g., 5-10) of excluded conversation segments that are temporally closest to the new message, for example. The generated summary may be included with the filtered conversation history in the prompt to the LLM. This may be useful to provide context to the LLM about the overall conversation (including unrelated topics) while still potentially reducing the computing resources (e.g., tokens) consumed in processing the prompt. Additionally or alternatively, by only providing a summary of the unrelated conversation segments, the influence of that unrelated context on the LLM-generated response to the new message may be tempered whilst giving the LLM an indication of previous interactions in the conversation session.

The filtered conversation history generated by the filtering module 260 and optionally the summary generated by the summarizer module 262 may be included, together with the new message, in a prompt to the LLM. The prompt to the LLM can be structured in any suitable way, with inclusion of the filtered conversation history as context. An example of a prompt that may be generated by the conversation engine 250 to the LLM may be as follows:
You are a help centre assistant here to answer a user's questions. You should provide answers based on your earlier conversation with the user.
Here is the recent relevant conversation that provides context:
{Filtered conversation history}
New message from the user:
{New message}
Output message:

If a summary was generated by the summarizer module 262, the generated summary may be included in the prompt by including, for example:
Here is a summary of other topics in the conversation, which should be given less weight:
{Summary}

The conversation engine 250 may provide the prompt to the LLM (e.g., via an API call). Because the prompt includes both the new message and the filtered conversation history, the LLM is prompted with relevant context when generating output in response to the prompt.

The conversation engine 250 receives the output generated by the LLM, and processes the output to provide the output message to the client system (e.g., via the optional chatbot UI 252 if the conversation session is a chat-based session). For example, if the LLM-generated output includes code to be rendered, the chatbot UI 252 may render the code such that the output message includes rendered elements, such as rendered user interface elements.

The output message may be processed as a new message in the conversation session, as discussed above, and added to the conversation history data object 256.

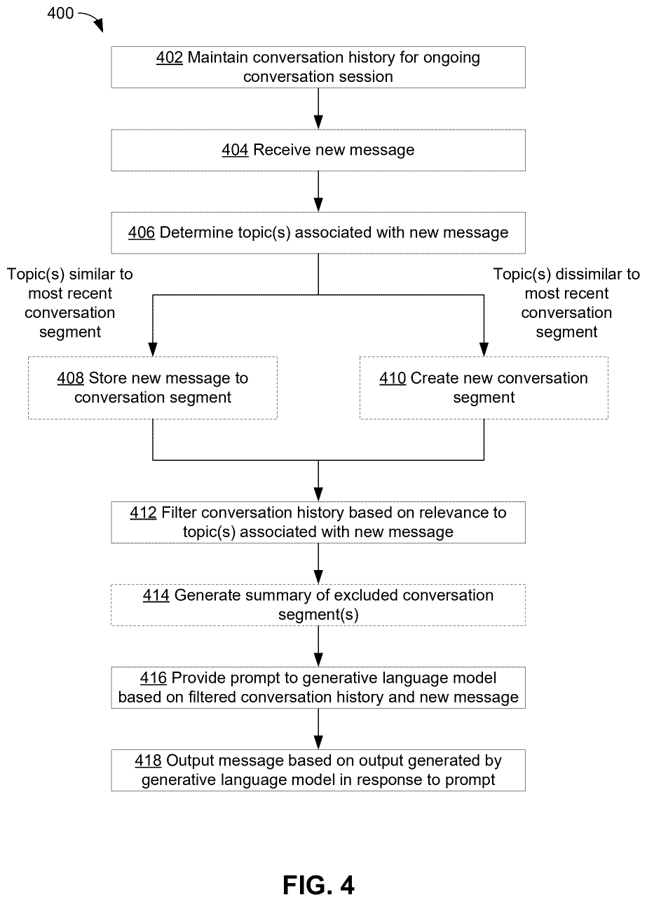

FIG. 4 is a flowchart of an example method 400 for an example embodiment of the present disclosure, which may be performed by a computing system, in accordance with examples of the present disclosure. For example, a processing unit of a computing system (e.g., the processor 202 of the computing system 200 of FIG. 2) may execute instructions (e.g., instructions of the conversation engine 250) to cause the computing system to carry out the example method 400. The method 400 may, for example, be implemented by an online platform or a server. The method 400 may enable a LLM to be prompted with relevant segment(s) of a conversation history. The LLM may be a generative pre-trained transformer LLM, such as LLAMA, Falcon 40B, GPT-3, GPT-4 or ChatGPT, among others. Further, it should be understood that the LLM may be a multi-modal LLM (e.g., BLIP-2, CLIP, GPT-4V, etc.) that is capable of processing multi-modal inputs (e.g., inputs that include text, images, other media, and combinations thereof). Although an LLM is described in some examples, the present disclosure may be applicable to any generative model, including any generative text model or any generative multi-modal or multimedia model. Thus, it should be understood that the present disclosure is not intended to be limited to LLMs and is not intended to be limited to text-only messages. The operations of the conversation engine 250 as described above may illustrate an example implementation of the method 400.

The method 400 may be performed during an ongoing conversation session conducted between a client system and an LLM. In some examples, the conversation session may be a chat-based session between a user providing inputs via a user device that is the client system. For example, a user may access a UI (e.g., the chatbot UI 252 provided by the chatbot engine 250) via a user device, and may provide input messages and view output messages via the UI presented on the user device. In some examples, the conversation session may be an exchange of messages (e.g., system messages) between the client system and the LLM.

At an operation 402, the system maintains a conversation history for an ongoing conversation session. For example, the conversation history may be maintained in a memory of the system by the conversation engine 250 as the conversation history data object 256, which grows as new messages are added to the conversation session. The conversation history contains conversation segments of the ongoing conversation session, where each conversation segment includes one or more previous messages of the conversation session and each conversation segment is associated with at least one topic. If a conversation segment contains more than two messages, the messages may be temporally consecutive messages that are stored in temporal order. In examples where multiple topics may be associated with a message, two conversation segments that are associated with two respective different topics may have an overlapping message in common, where the overlapping message is associated with both of the two different topics.

At an operation 404, a new message for the ongoing conversation session is received (e.g., from a client system that is in communication with the system, in some cases via a UI provided by the conversation engine 250). The new message may contain text, image(s), audio and/or other suitable media.

At an operation 406, the system determines one or more topics associated with the new message. The operation 406 may be performed using the topic identifier module 258 of the conversation engine 250 as described above, for example. Various techniques may be used to determine the topic(s) associated with the new message, some of which are described herein. It should be understood that the present disclosure is not limited to the specific techniques for determining a topic as described herein, and different techniques may be used in combination.

In some examples, a sliding window may be used to help determine the topic(s) associated with the new message. A sliding window may be used to define a defined number (e.g., up to 5) of most recent messages (i.e., the messages immediately preceding the current new message). Then the topic(s) associated with the new message may be determined while taking into account the context of the recent messages defined by the sliding window. For example, the new message may be provided together with the recent messages defined by the sliding window to a trained model (e.g., a trained NLP model, a trained multi-class classifier, a LLM, etc.) to predict one or more topics.

In some examples, a clustering algorithm may be used to help determine the topic(s) associated with the new message. The previous messages in the conversation session (e.g., all messages contained in the conversation history data object 256) may be clustered using a suitable clustering algorithm, where each cluster corresponds to a respective conversation segment associated with at least one respective topic. Then the topic(s) associated with the new message may be determined by using the clustering algorithm to cluster the new message with a particular cluster. The topic(s) associated with that particular cluster may then be determined to be the topic(s) associated with the new message. If the new message cannot be clustered with any existing cluster, this may indicate that the topic(s) associated with the new message is not related to any previously discussed topics in the ongoing conversation session, in which case the new message may be provided as input to a trained model (e.g., a trained NLP model, a trained multi-class classifier, a LLM, etc.) to predict one or more topics associated with the new message.

Depending on whether the topic(s) associated with the new message is similar or dissimilar to the most recent conversation segment (that is, the conversation segment that is temporally closest to the new message in the conversation session), following the operation 406, an operation 408 or an operation 410 may be performed.

At the operation 408, it is determined, based on the topic(s) associated with the new message, that a particular conversation segment in the conversation history that is temporally closest to the new message is associated with at least one topic that is similar to or the same as at least one of the topic(s) associated with the new message. This means that the message(s) stored in the most recent conversation segment are relevant to the topic(s) associated with the new message. The new message is then stored to the particular most recent conversation segment in the conversation history, thus increasing the size of (or “growing”) the most recent conversation segment.

At the operation 410, it is determined, based on the topic(s) associated with the new message, that all of the topic(s) associated with a particular conversation segment in the conversation history that is temporally closest to the new message are dissimilar to the topic(s) associated with the new message. This means that the message(s) stored in the most recent conversation segment are less relevant or irrelevant to the topic(s) associated with the new message. Instead of storing the new message with the existing most recent conversation segment, a new conversation segment is created in the conversation history (e.g., by creating a new record in the conversation history data object 256). The newly created conversation segment is associated with the topic(s) associated with the new message and the new message is stored to the newly created conversation segment. The operation 410 may be performed even if there is another older conversation segment (i.e., not the conversation segment that is temporally closest to the new message) that is associated with topic(s) similar to or same as the topic(s) associated with the new message.

Following operation 408 or 410, an operation 412 is performed. At the operation 412, the conversation history is filtered based on relevance to the topic(s) associated with the new message. This may be performed using the filtering module 260 of the conversation engine 250 as described above, for example. As a result of the filtering, a filtered conversation history is obtained that has at least one relevant conversation segment associated with at least one relevant topic that is relevant to the topic(s) associated with the new message. The filtered conversation history may be a new data object different from the conversation history data object 256. The filtered conversation history may be obtained by selecting, from the conversation history, only the conversation segment(s) associated with relevant topic(s); alternatively, the filtered conversation history may be obtained by excluding, from the conversation history, the conversation segment(s) associated with irrelevant or less relevant topic(s).

Identifying a conversation segment associated with a relevant topic may be performed using a variety of techniques, some of which are described herein. It should be understood that the present disclosure is not limited to the specific techniques for identifying a relevant conversation segment as described herein, and different techniques may be used in combination.

In some examples, if a clustering algorithm was used to determine the topic(s) associated with the new message, then the particular cluster to which the new message has been clustered may correspond to a conversation segment that is relevant to the new message. In such a case, filtering the conversation history may involve selecting the conversation segment corresponding to the particular cluster that the new message has been clustered with.

In some examples, a measure of similarity (e.g., based on similarity of corresponding embeddings, for example using Euclidean distance between embeddings in the embedding space as a measure of similarity) between the topic(s) associated with the new message and the topic(s) associated with each conversation segment may be used to identify a relevant conversation segment. A relevant topic that is relevant to the topic(s) associated with the new message may have a measure of similarity that satisfies a defined threshold (e.g., a Euclidean distance between corresponding embeddings that is within a defined threshold). The conversation segment topic(s) that correspond to embedding(s) that are closest, in the embedding space, to the embedding(s) corresponding to topic(s) of the new message may be identified as the relevant topic(s). Then the conversation segment(s) associated with the relevant topic(s) may be included in the filtered conversation history, or the conversation segment(s) associated with topic(s) other than the relevant topic(s) may be excluded from the filtered conversation history. In some examples, the filtered conversation history may be a summary generated from the conversation segment(s) associated with the relevant topic(s).

In some examples, conversation segment(s) associated with the relevant topic(s) but exceeding a temporal threshold (e.g., older than 1 hour) may be summarized (e.g., using the optional summarizer module 262) and the summary included in the filtered conversation history, while more recent relevant conversation segment(s) may be included in the filtered conversation history without summarizing. This may be useful to provide some context from older relevant messages and provide details from more recent messages, as well as avoiding using up a large number of tokens on older messages.

In some examples, the conversation history may be filtered to exclude conversation segment(s) that exceed some temporal threshold (e.g., older than 1 hour), regardless of topic.

Optionally, at an operation 414, a summary of at least one of the excluded conversation segments may be generated. This may be performed using the optional summarizer module 262 of the conversation engine 250 as described above, for example. In some examples, the summary may be generated only for excluded conversation segments that are within a defined temporal threshold (e.g., within 1 hour). The summary may be generated using any suitable technique, such as using a trained NLP model, or a trained LLM model, among other possibilities.

At an operation 416, a prompt is provided to a generative language model (e.g., a LLM as discussed above) based on the filtered conversation history and the new message. In some examples, if optional operation 414 was performed, the prompt may be further based on the summary generated at the operation 414. The prompt may be provided to the generative language model by, for example, making an API call to a remote server hosting the generative language model.

At an operation 418, a message is provided to the conversation session (e.g., provided as a message to the client system, or outputted to be viewed on the user device that is the client system, etc.), based on the output generated by the generative language model in response to the prompt.

The message that is outputted at the operation 418 is also added to the conversation history. The output message may be processed in a manner similar to operations 406-410 as discussed above.

In some examples, in addition to maintaining a conversation history of the ongoing conversation session, in which the conversation history is dynamic and growing, a historical database may also be maintained (e.g., in a memory of the system or in a remote server). The historical database may contain historical messages from one or more historical conversation sessions conducted by the client system (e.g., if the client system is associated with a registered account, then historical conversation sessions conducted by the client system may be saved to the client profile and can be retrieved when the registered client conducts a new conversation session).

A historical conversation session is a conversation session that is no longer active (i.e., is not an ongoing conversation session) and may be a static data object. A historical conversation session may have been previously processed in the manner described above such that the historical conversation session contains historical conversation segments that are each associated with at least one topic, with each historical conversation segment including one or more historical messages from the historical conversation session. The system may, in addition to identifying a conversation segment of the current ongoing conversation session that is associated with a relevant topic, also identify a historical conversation segment that is associated with a relevant topic. The prompt provided to the generative language model at the operation 416 may be additionally based on the identified historical conversation segment that is associated with a relevant topic. In this way, the generative language model may be provided with contextual information from the ongoing conversation session, and also contextual information from older conversation sessions.

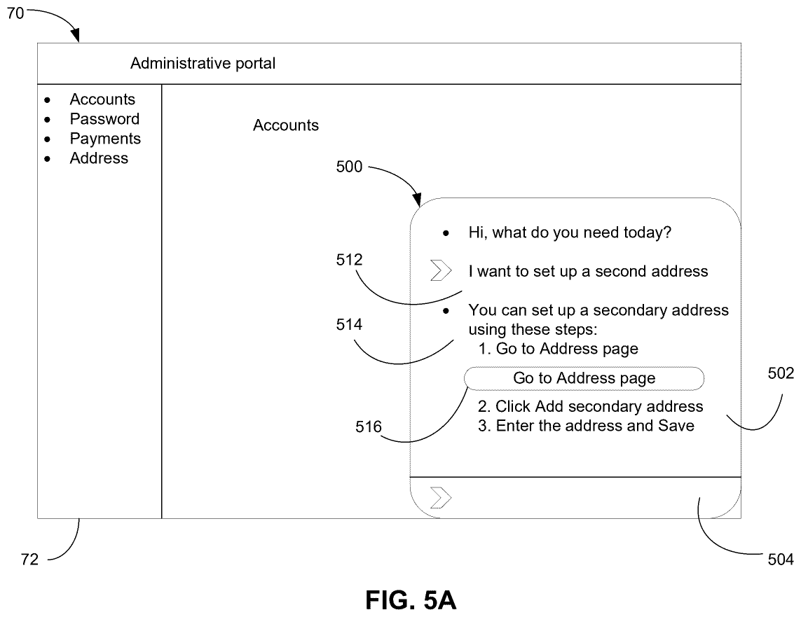

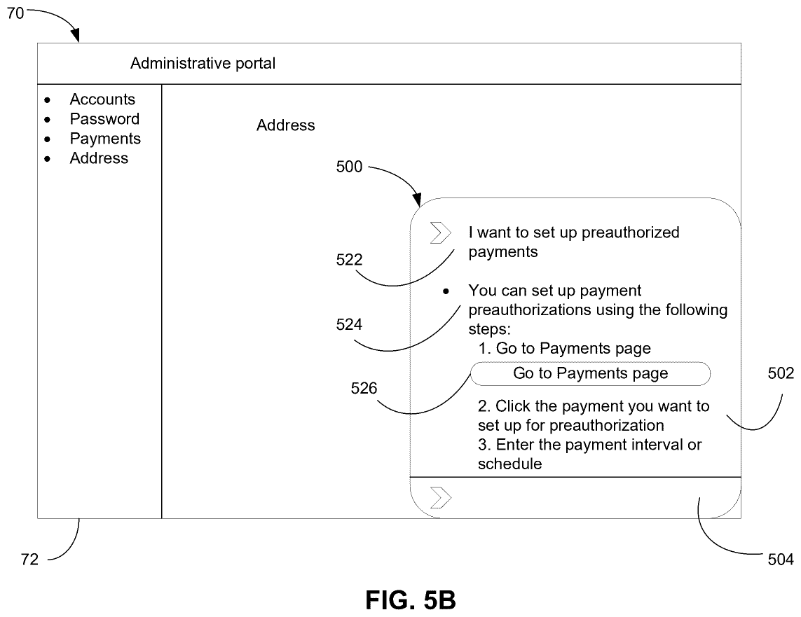

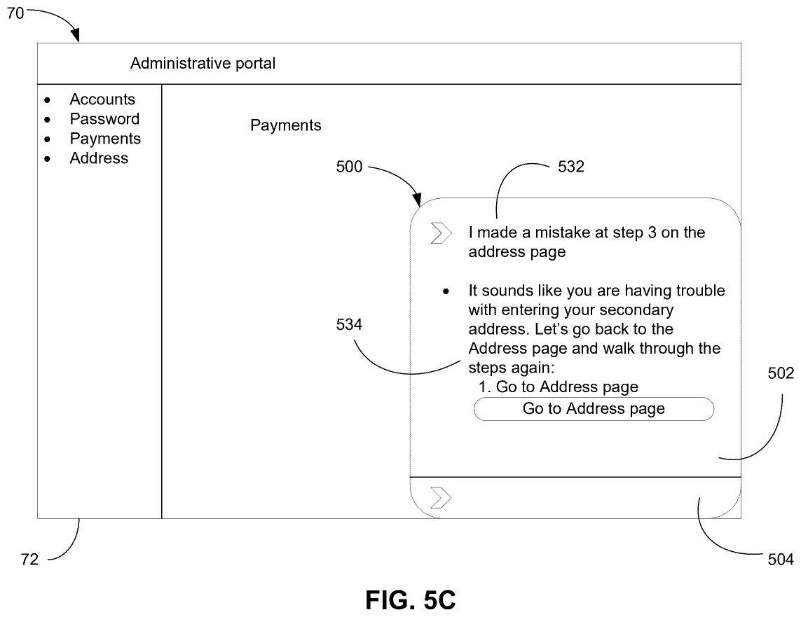

FIGS. 5A-5C illustrate an example of a simplified chatbot UI, which may be implemented by an example of the conversation engine 250 as disclosed herein (e.g., using the example method 400), in the context of conversation session that is a chat-based session. In this example, the ongoing conversation session is conducted in the context of a virtual assistant for a web portal being navigated by a user via a client system that is a user device. In this simple example, the user is viewing and navigating through an administrative portal 70 that has multiple pages or tabs, as indicated in the navigation bar 72. It should be understood that this example is not intended to be limiting.

An interface 500 for an ongoing conversation session (e.g., provided by the disclosed conversation engine 250) is presented to the user. The interface 500 includes a partial conversation history 502 displaying the most recent messages in the conversation session and an input portion 504 in which the user may enter input, such as text input, image input, etc. In some examples, the user may provide input by other means, such as voice input and/or touch input.

In FIG. 5A, the user has provided an input message 512 asking about setting up a second address, which was previously processed by the conversation engine 250, using an LLM, to provide the output message 514 including steps 1, 2 and 3 for setting up a secondary address. In this example, the output message 514 includes a user interface element 516 that the user can select to perform step 1 (“Go to Address page”). The user interface element 516 may be rendered by the chatbot UI 252, from code included in the output generated by the LLM, for example. Using examples of the present disclosure, the messages 512, 514 may be determined to be associated with the topic “secondary address”, and may be stored in a conversation segment associated with the topic “secondary address” in the conversation history data object 256.

In FIG. 5B, some time after the messages 512, 514, the user has provided another input message 522 asking about setting up preauthorized payments, and the conversation engine 250 has provided an output message 524 including steps 1, 2 and 3 for setting up a payment preauthorization. In this example, the output message 524 includes another user interface element 526 that user can select to perform step 1 (“Go to Payments page”). Using examples of the present disclosure, the messages 522, 524 may be determined to be associated with the topic “preauthorized payment”, and may be stored in another conversation segment associated with the topic “preauthorized payment” in the conversation history data object 256.

In FIG. 5C, some time after the messages 522, 524, the user has provided another input message 532 asking about step 3 performed on the Address page. Using examples of the present disclosure, the conversation engine 250 may determine that the topic of the input message 532 is “address mistake”, and that the conversation segment with the topic “secondary address” is relevant while the conversation segment with the topic “preauthorized payment” is not relevant. Accordingly, the conversation engine 250 provides a prompt to the LLM based on the input message 532 and the filtered conversation history that includes the conversation segment containing messages 512, 514 but excludes the conversation segment containing messages 522, 524, despite the messages 522, 524 being more recent than the messages 512, 514. This helps to ensure that the prompt to the LLM includes relevant context (e.g., the messages 512, 514) but does not include irrelevant or misleading context (e.g., the messages 522, 524 could be misleading about the meaning of “step 3”). The conversation engine 250 provides an output message 534 based on output generated by the LLM, in particular the output message 534 correctly reflects the user's intention to correct an error related to step 3 of setting up a secondary address.

In the example of FIGS. 5A-5C, messages in the conversation session may include user interface elements rendered by the chatbot UI 252. In some examples, the code required for rendering a user interface element may be identified as being associated with a unique topic (e.g., labeled with a unique tag such as “UI_code”), such that the code will not be identified as being associated with a topic relevant to any message. This may ensure that the code will not be included in the filtered conversation history and will not be provided as context information to the LLM. This may help to avoid the problem of the LLM generating erroneous code, due to the presence of code in the context information. Additionally, exclusion of code from the prompt may help to reduce the resources (e.g., tokens) consumed when providing a prompt to the LLM.

Examples of the present disclosure may enable more efficient and/or more accurate operation of an LLM or a chatbot based on an LLM. A conversation engine as disclosed herein may be used in various implementations, such as on a website, a portal, a software application, etc. In an example, the disclosed conversation engine may be implemented on an e-commerce platform, for example to help a user (e.g., a merchant, store owner or store employee) with tasks on an administrative webpage or portal of an online store. In another example, the disclosed conversation engine may be used to enable exchange of messages between a client system and an LLM.

In various examples, the present disclosure provides a technical solution that enables an LLM to be provided with relevant contextual information in a prompt related to a message in a conversation session. This enables the LLM to generate more accurate output, while at the same time avoiding consumption of resources (e.g., processing power, tokens, etc.) to process less relevant information.

In examples of the present disclosure, a conversation history is maintained for an ongoing conversation session, where the conversation history is dynamic (e.g., the conversation history data object is a dynamic data object that can increase in size as the conversation session proceeds). Compared to techniques that draw from a database of static knowledge documents, the conversation history is more dynamic and specific to the current conversation session. The conversation history maintains messages, segmented into conversation segments, in their original consecutive temporal order, the order of the messages can be maintained, which can also provide useful contextual information to the LLM.

Although the present disclosure includes examples of transformer-based language models, it should be understood that the present disclosure may be applicable to any machine learning-based language model, including language models based on other neural network architectures such as recurrent neural network (RNN)-based language models or state space models (SSMs) (e.g., Hyena). Examples involving the use of an LLM is merely by way of example and the present disclosure is not necessarily so limited. For example, the techniques disclosed herein could potentially also be applied to other generative models such as, for example, other text generation models or multimedia models such as may serve to generate other forms of output or accept other forms of input beyond text (and which may, in some implementations, potentially include a generative text model along with one or more other models). In a specific example, a generative model (e.g., a multimedia model) that includes, amongst other types of models, an LLM in it, may be employed in association with the above-discussed techniques.

In some examples, there is provided a computer-implemented method including: obtaining a message history (e.g., a conversation history) corresponding to prior inputs to and outputs from a generative model, the message history grouped into portions (e.g., conversation segments), the portions having topics associated therewith; receiving a further message; analyzing the further message to identify one or more topics associated therewith; filtering the message history based on the one or more topics associated with the further message yielding a filtered message history (e.g., a filtered conversation history); and providing input to a generative text model based on the filtered message history and the further message.

In some examples, the method may include: grouping the message history into the portions.

In some examples, the method may include: identifying topics associated with the portions.

In some examples, the generative model may be a first generative model, and the topics may be identified using a second generative model.

In some examples, the first generative model may be the same type of model as the second generative model.

In some examples, the first generative model may be the same model instance as the second generative model.

In some examples, the second generative model may be or may include a large language model (LLM).

In some examples, the topics may be identified using one or more natural language processing techniques.

In some examples, the topics may be identified based on an embedding model.

In some examples, the portions may correspond to groups of sequential messages (e.g., temporally consecutive messages) sharing at least one common topic.

In some examples, the portions may be non-overlapping segments.

In some examples, filtering the message history based on the one or more topics associated with the further message may include excluding at least some of the portions having topics associated therewith that are irrelevant (or less relevant) to the one or more topics associated with the further message.

In some examples, a first topic being irrelevant to a second topic may be determined based on a similarity of the first topic and the second topic (e.g., a similarity of embeddings corresponding to the first and second topics; or a similarity based on clustering of topics).

In some examples, the first topic being irrelevant to the second topic may be determined based on a measure of similarity of the first topic and the second topic being less than a threshold measure (e.g., a measure of similarity may be based on a measure of distance between embeddings corresponding to the first and second topics in the embedding space).

In some examples, the threshold measure may be a defined measure.

In some examples, the threshold measure may be determined based on measures of similarity between the one or more topics associated with the further message and the topics associated with the portions.

In some examples, the threshold measure may be selected so that the exclusion of the at least some of the portions having topics associated therewith that are irrelevant to the one or more topics associated with the further message results in a filtered message history of or less than a defined length (e.g., no more than a defined number of messages, no more than a defined number of tokens, no more than a defined amount of data, etc.).

In some examples, filtering the message history based on the one or more topics associated with the further message may include replacing at least some of the portions having topics associated therewith that are irrelevant to the one or more topics associated with the further message in the filtered message history with summaries of the at least some of the portions.

In some examples, the generative model may be a first generative model and the summaries of the at least some of the portions are generated using a second generative model.

In some examples, the first generative model may be the same type of model as the second generative model.

In some examples, the first generative model may be the same model instance as the second generative model.

In some examples, the second generative model may be or may include a large language model (LLM).

In some examples, the summaries of the at least some of the portions may be generated using one or more natural language processing techniques.

In some examples, the method may include: receiving an output from the generative model responsive to the input.

In some examples, the method may include: providing a response message based on the received message, the response message responding to the further message.

In some examples, the further message may be based on user input to an interactive chat (e.g., an ongoing conversation session) and the response message may be provided to the user via the interactive chat.

In some examples, the message history may provide a history of messages in the interactive chat.

In some examples, the method may include: updating the message history, the updating including appending the response message to the message history.

In some examples, the method may include: determining topics associated with the output.

In some examples, the topics associated with the output may be determined using at least one of an LLM, natural language processing techniques, and/or an embedded model.

In some examples, the method may include: appending a message based on the output to the message history.

In some examples, the appended message may be included in one or more portions of the message history based on one or more topics determined for the appended message.

In some examples, the method may include: updating the message history based on the output.

In some examples, the method may include: updating the message history, the updating including appending the further message to the message history.

In some examples, the further message as appended may be included in one or more portions of the message history based on the identified one or more topics associated therewith.

In some examples, the generative model may be or may include a text generation model.

In some examples, the generative model may be or may include a large language model (LLM).

In some examples, there is provided a computer system including: at least one processor; a computer readable medium storing instructions that, when executed by the at least one processor, cause the computer system to perform the method of any one of the preceding examples.

In some examples, there is provided a computer readable medium storing instructions that, when executed by at least one processor of a computer system, cause the computer system to perform the method of any one of the preceding examples.

Although the present disclosure has described a LLM in various examples, it should be understood that the LLM may be any suitable language model (e.g., including LLMs such as LLAMA, Falcon 40B, GPT-3, GPT-4 or ChatGPT, as well as other language models such as BART, among others).

Although the present disclosure describes methods and processes with operations (e.g., steps) in a certain order, one or more operations of the methods and processes may be omitted or altered as appropriate. One or more operations may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. Any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

Memory, as used herein, may refer to memory that is persistent (e.g. read-only-memory (ROM) or a disk), or memory that is volatile (e.g. random access memory (RAM)). The memory may be distributed, e.g. a same memory may be distributed over one or more servers or locations.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer-implemented method comprising:
maintaining a conversation history for an ongoing conversation session, the conversation history containing conversation segments of the ongoing conversation session, each conversation segment being associated with at least one topic, and each conversation segment including one or more previous messages in the ongoing conversation session;
receiving a new message for the ongoing conversation session;
determining one or more topics associated with the new message;
filtering the conversation history based on relevance to the one or more topics associated with the new message to obtain a filtered conversation history having at least one relevant conversation segment associated with at least one topic that is relevant to the one or more topics associated with the new message;
providing a prompt to a generative language model based on the filtered conversation history and the new message; and
providing an output message based on output generated by the generative language model in response to the prompt.

2. The method of claim 1, further comprising:
determining, based on the one or more topics associated with the new message, that a particular conversation segment in the conversation history that is temporally closest to the new message is associated with at least one topic that is similar to or same as at least one of the one or more topics associated with the new message; and
storing the new message to the particular conversation segment in the conversation history.

3. The method of claim 1, further comprising:
determining, based on the one or more topics associated with the new message, that all of the at least one topic associated with a particular conversation segment in the conversation history that is temporally closest to the new message are dissimilar to the one or more topics associated with the new message;
creating a new conversation segment in the conversation history associated with the one or more topics associated with the new message; and
storing the new message to the new conversation segment.

4. The method of claim 1, wherein at least two conversation segments in the conversation history that are associated with at least two respective different topics have at least one overlapping message in common, the at least one overlapping message being associated with both of the at least two respective different topics.

5. The method of claim 1, wherein the one or more previous messages stored in each conversation segment are temporally consecutive messages stored in temporal order.

6. The method of claim 1, wherein filtering the conversation history comprises:
identifying the at least one relevant topic based on a measure of similarity between the at least one relevant topic and the one or more topics associated with the new message; and
excluding at least some conversation segments in the conversation history that are associated with topics other than the at least one relevant topic.

7. The method of claim 6, further comprising:
generating a summary of at least one of the excluded conversation segments;
wherein the prompt provided to the generative language model is further based on the generated summary.

8. The method of claim 1, wherein the ongoing conversation session is associated with an account, the method further comprising:
maintaining a historical database containing historical messages from one or more historical conversation sessions associated with the account, the historical database containing historical conversation segments that each belong to a respective historical conversation session, each historical conversation segment being associated with at least one topic, and each historical conversation segment including one or more historical messages of the respective historical conversation session; and
identifying at least one historical conversation segment associated with the at least one relevant topic that is relevant to the one or more topics associated with the new message;
wherein the prompt provided to the generative language model is further based on the identified at least one historical conversation segment.

9. The method of claim 1, wherein determining the one or more topics associated with the new message comprises:
using a sliding window to define a defined number of one or more most recent messages;
providing the new message together with the one or more most recent messages to a trained model; and
receiving the one or more topics as output from the trained model.

10. The method of claim 1, wherein:
previous messages in the ongoing conversation session are clustered, each cluster corresponding to a conversation segment associated with at least one topic;
determining the one or more topics associated with the new message comprises:
using a clustering algorithm to cluster the new message with a particular cluster; and
determining the one or more topics associated with the new message based on the at least one topic associated with the conversation segment corresponding to the particular cluster; and
filtering the conversation history comprises:
selecting the conversation segment corresponding to the particular cluster as the filtered conversation history.

11. A computer system comprising:
at least one processor; and
a computer readable medium storing instructions that, when executed by the at least one processor, cause the computer system to:
maintain a conversation history for an ongoing conversation session, the conversation history containing conversation segments of the ongoing conversation session, each conversation segment being associated with at least one topic, and each conversation segment including one or more previous messages in the ongoing conversation session;
receive a new message for the ongoing conversation session;
determine one or more topics associated with the new message;
filter the conversation history based on relevance to the one or more topics associated with the new message to obtain a filtered conversation history having at least one relevant conversation segment associated with at least one topic that is relevant to the one or more topics associated with the new message;
provide a prompt to a generative language model based on the filtered conversation history and the new message; and
provide an output message based on output generated by the generative language model in response to the prompt.

12. The computer system of claim 11, wherein the instructions when executed by the at least one processor further cause the computer system to:
determine, based on the one or more topics associated with the new message, that a particular conversation segment in the conversation history that is temporally closest to the new message is associated with at least one topic that is similar to or same as at least one of the one or more topics associated with the new message; and
store the new message to the particular conversation segment in the conversation history.

13. The computer system of claim 11, wherein the instructions when executed by the at least one processor further cause the computer system to:
determine, based on the one or more topics associated with the new message, that all of the at least one topic associated with a particular conversation segment in the conversation history that is temporally closest to the new message are dissimilar to the one or more topics associated with the new message;
create a new conversation segment in the conversation history associated with the one or more topics associated with the new message; and
store the new message to the new conversation segment.

14. The computer system of claim 11, wherein at least two conversation segments in the conversation history that are associated with at least two respective different topics have at least one overlapping message in common, the at least one overlapping message being associated with both of the at least two respective different topics.

15. The computer system of claim 11, wherein the one or more previous messages stored in each conversation segment are temporally consecutive messages stored in temporal order.

16. The computer system of claim 11, wherein the instructions when executed by the at least one processor further cause the computer system to filter the conversation history by:
identifying the at least one relevant topic based on a measure of similarity between the at least one relevant topic and the one or more topics associated with the new message; and
excluding at least some conversation segments in the conversation history that are associated with topics other than the at least one relevant topic.

17. The computer system of claim 16, wherein the instructions when executed by the at least one processor further cause the computer system to:
generate a summary of at least one of the excluded conversation segments;
wherein the prompt provided to the generative language model is further based on the generated summary.

18. The computer system of claim 11, wherein the instructions when executed by the at least one processor further cause the computer system to determine the one or more topics associated with the new message by:
using a sliding window to define a defined number of one or more most recent messages;
providing the new message together with the one or more most recent messages to a trained model; and
receiving the one or more topics as output from the trained model.

19. The computer system of claim 11, wherein previous messages in the ongoing conversation session are clustered, each cluster corresponding to a conversation segment associated with at least one topic;
wherein the instructions when executed by the at least one processor further cause the computer system to determine the one or more topics associated with the new message by:
using a clustering algorithm to cluster the new message with a particular cluster; and
determining the one or more topics associated with the new message based on the at least one topic associated with the conversation segment corresponding to the particular cluster; and wherein the instructions when executed by the at least one processor further cause the computer system to filter the conversation history by:
selecting the conversation segment corresponding to the particular cluster as the filtered conversation history.

20. A non-transitory computer-readable medium storing instructions that, when executed by at least one processor of a computer system, cause the computer system to:
maintain a conversation history for an ongoing conversation session, the conversation history containing conversation segments of the ongoing conversation session, each conversation segment being associated with at least one topic, and each conversation segment including one or more previous messages in the ongoing conversation session;
receive a new message for the ongoing conversation session;
determine one or more topics associated with the new message;
filter the conversation history based on relevance to the one or more topics associated with the new message to obtain a filtered conversation history having at least one relevant conversation segment associated with at least one topic that is relevant to the one or more topics associated with the new message;
provide a prompt to a generative language model based on the filtered conversation history and the new message; and
provide an output message based on output generated by the generative language model in response to the prompt.
